(19) United States
(12) Patent Application Publication
(10) Pub. No.: US 2023/0405696 A1
(43) Pub. Date: Dec. 21, 2023

(54) METHOD FOR GRINDING A TOOTHING OR A PROFILE OF A WORKPIECE

(71) Applicant: KAPP NILES GMBH & CO. KG, Coburg (DE)

(72) Inventors: Christopher GOEBEL, Ahorn (DE); Philip GEILERT, Ahorn (DE); Sven THIERFELDER, Mitwitz (DE)

(21) Appl. No.: 18/036,214

(22) PCT Filed: Oct. 20, 2021
(86) PCT No.: PCT/EP2021/079111

§ 371 Date: May 10, 2023

(30) Foreign Application Priority Data
Nov. 12, 2020 (DE) 10 2020 129 930.3

(51) Int. Cl. B23F 1/02; B23F 23/12

(52) U.S. Cl. CPC B23F 1/023; B23F 23/1218

(57) ABSTRACT

A method for grinding a toothing of a workpiece with a grinding tool in a grinding machine, wherein during the engagement of the grinding tool in the toothing to be ground, a first and a second machine parameter are measured, and both machine parameters measured are compared with a predefined stored value, wherein a signal is output if at least one of the machine parameters exceeds or falls below the predefined stored value, taking account of a tolerance range. To enable a conclusion to be drawn about the course of the grinding process by monitoring relevant variables, at least one of the machine parameters contains periodic signal components, wherein the signal components are broken down by a frequency analysis into the individual frequency components and the frequency components are used, with regard to their frequency and/or amplitude, for comparison.

The invention relates to a method for grinding a toothing or a profile of a workpiece by means of a grinding tool in a grinding machine, wherein the grinding tool is received on a tool spindle and the tool spindle is rotated by means of a first drive motor, wherein the workpiece is received on a workpiece spindle and the workpiece spindle is rotated by means of a second drive motor, wherein at least during the engagement of the grinding tool in the toothing to be ground or in the profile to be ground, a first and a second machine parameter are measured and both measured machine parameters or a variable derived from the machine parameter are compared with a predetermined stored value, wherein a signal is output if at least one of the machine parameters or the variable derived therefrom, taking into account a tolerance band, exceeds or falls below the predetermined stored value:

Such a method is known from WO 2020/193228 A1. Here, monitoring of the type described is carried out in order to be able to detect whether a grinding wheel breakout has occurred in a grinding worm, wherein in the given case a warning indicator is output which indicates an impermissible process deviation.

When monitoring the grinding process, it is generally known to observe a relevant process parameter, for example the current consumption of the motor that drives the grinding spindle, and to check whether the value lies within a predefined tolerance band over the course of a grinding stroke, which naturally changes over the course of the grinding stroke. If the value leaves the tolerance band, a signal is output which indicates that the process is not in proper condition. The defined tolerance band can be understood as a value range that has been “learned” by the system and is based on past experience. For the relevant state of the art, reference is made to the tool monitoring of Nordmann GmbH & Co. KG, Huerth, DE (see: https://www.nordmann.eu/huellkurven.html).

In fact, it is possible by doing so to make a statement about the course of the grinding process, especially from the point of view of whether a proper workpiece was ground. However, it has been found that in many cases this is not sufficient to make a sufficient statement about the course of the grinding process and the quality of the ground workpiece. In particular, it is difficult to draw conclusions about the cause of the defect if there was no proper grinding process.

The invention is based on the object of further developing a generic process in such a way that it is possible to draw improved conclusions about the course of the grinding process by monitoring relevant variables. Thus, it should be possible to better assess whether a proper workpiece has been ground. If necessary, it should also be possible to derive indications as to which problems caused the grinding process not to proceed properly. Thus, one object of the present invention consists in a process-safe monitoring of the grinding process and a monitoring of the workpiece quality that is as complete as possible, which should be possible quickly and inexpensively and thus without downstream external measurement of the ground workpiece, in particular the gearwheel.

The solution to this object by the invention provides that at least one of the machine parameters or the variable derived from this machine parameter contains periodic signal components, wherein these signal components are broken down into the individual frequency components by a frequency analysis and the frequency components being used for comparison with regard to their frequency and/or their amplitude.

Preferably, both machine parameters or the variables derived from these machine parameters contain periodic signal components.

Preferably, the frequency components are only used for comparison with regard to their amplitude.

According to a preferred procedure, the frequency analysis is carried out by means of a Fast Fourier Transform (FFT).

However, alternative and known methods can also be used, in particular a Discrete Fourier Transform (DFT), a root mean square analysis (determination of the RMS spectrum), a determination of the amplitude spectrum, a cepstrum analysis, a compensation sinus function or a determination of the auto power spectrum (PSD analysis). The mentioned procedures for signal analysis are known as such and therefore do not need to be discussed in detail here.

The measurement of the first and second machine parameters can take place during a predefined time interval while the workpiece is being ground with the grinding tool.

It is also possible that the measurement of the first and second machine parameters takes place over a predetermined feed path when grinding the workpiece with the grinding tool. The parameters mentioned (in particular the grinding power of the tool spindle) are thus not considered in time, but locally (over the course of the grinding stroke). This makes it possible to look at particularly relevant sections and make comparisons with already stored data.

According to a preferred embodiment of the invention, the first machine parameter is the current consumption of the motor of the tool spindle. The second machine parameter is preferably the current consumption of the motor of the workpiece spindle.

As far as the power or current consumption of the tool motor is concerned, according to a further embodiment of the invention, it is provided that from the course of the total current consumption of the motor, the course of the current consumption is subtracted, which results in a grinding stroke without cutting material (or in the case of carrying out only a finishing stroke, which only consumes comparatively little energy). In this respect, this approach does not consider the total spindle power, but only the cutting power. The portion that results from an idle stroke (or a finishing stroke) is therefore subtracted from the total power consumption. During the idle stroke (or the finishing stroke), only the power loss is recorded, such as that caused by the bearings of the axes or by hydrodynamic losses due to the cooling lubricant.

When we speak here of the current consumption (I) of the motors, we are of course also referring to the absorbed power (P) of the motors, which can be calculated via the relationship

$$P = \overline{p} = \frac{1}{T} {{\int }_{{t}_{0}}}^{{t}_{0} + T} u \cdot i dt$$

which is given when voltage U is applied.

One of the detected machine parameters can also be the structure-borne sound of the grinding machine or a part of it, whereby the structure-borne sound is detected via a structure-borne sound sensor.

An alternative is that the variable derived from the machine parameter is the cutting energy per volume (measured in J/mm³) required to machine a given volume of the allowance to be removed on the toothing or on the profile. The power or current consumption of the tool spindle can be used to determine the energy consumed for a defined period of time, which is required to machine the stock allowance (in particular after deducting the portions that are not due to machining, see above). Taking into account the geometry of the tool (grinding worm) and the toothing or profile as well as the process parameters (in particular the infeed of the tool to the workpiece), the corresponding machined volume can then be determined. With the mentioned parameter of the cutting energy per volume, the transferability between different grinding processes (especially generating grinding processes) with different workpieces is facilitated.

From the measured machine parameters and/or from the variable derived from the machine parameter, a characteristic value can be determined and output, which characterises the grinding process for the ground workpiece.

The grinding tool is preferably a grinding worm and the workpiece a gear wheel.

In this respect, the proposed concept provides for monitoring and evaluation of the grinding process, in particular the generating grinding process, by combining several signals, whereby at least two different process parameters are considered. For each ground workpiece, a characteristic value can be defined that provides information about the grinding process that has been carried out.

The described procedure effectively monitors the grinding process and detects faulty or conspicuous components at an early stage. In particular, defects on the blank of the workpiece, waviness on the flanks of the ground gear and also tool defects are detected.

The assessment is carried out by reverting to data stored (in the machine control) and thus learned knowledge from previous grinding processes. Process deviations (anomalies) can thus be detected more effectively so that the machine operator can be given a warning or the grinding process can be stopped.

During machining, as the case may be several signals internal to the control system (i.e. those present in the machine control system) and also signals external to the control system (e.g. recorded via sensors that pick up structure-borne noise, which originates from the machine bed or the hall floor, for example) are recorded and taken into account.

In addition, machine-internal data (such as set corrections, the diameter of the grinding worm, generated paths along which the workpiece and the tool are guided relative to each other) can be used to assess the process, for which purpose they are adaptively filtered and sorted if necessary (for example, by subdividing the entire grinding process into different strokes, subdividing into infeed, outfeed and complete engagement of workpiece and tool).

Depending on the variables influencing the process, especially with regard to the generated course (influenced by screw diameter and corrections), characteristic values can be calculated and output.

In addition to the previously known methods (see above), characteristic values for the mentioned subdivision (statistical characteristic values, such as standard deviation, variance, kurtosis, skewness, frequency distributions, classification in percentiles, slope, area contents) can be determined from the individual recorded signals; this also applies to the determination of characteristic values from the signal analysis (such as frequency, amplitude, order analysis).

For a general validity of the determined data for different grinding processes and thus for the transferability, the mentioned characteristic values can be standardised. For this purpose, for example, the related metal removal rate, the related grinding power, the related cutting force and the contact time between workpiece and tool are used.

The combination of the different characteristic values obtained from the various sensor signals provides information about the grinding process.

With the help of algorithms from statistics and in particular with algorithms from the field of machine learning, these data are evaluated and the quality of the editing process is determined. The well-known algorithms from the field of machine learning include both supervised and unsupervised learning, “deep learning” and “reinforcement learning”.

This makes it possible to increase the monitoring quality and thus stabilise the grinding process. It can be recognised in an improved way whether it is a faulty process, whereby the type of fault can also be identified in an improved way. The prerequisite for this is that such an error or a similar error has been taught in the data stored (in the machine control).

In addition to recognising the error case, this also enables faster troubleshooting. Building on this knowledge, the machine is able to adaptively intervene in the process and optimise it.

As mentioned, the measurement signals in the process can be divided into areas that are meaningful for the evaluation of the process on the basis of knowledge about the grinding process. Thus, the entire machining process is not necessarily assessed, but only relevant areas.

The proposed procedure thus monitors the grinding process and assesses it index-based. This means that an index, i.e. a numerical value, is calculated for each individual workpiece, which assesses the quality of the grinding process. These index values can then be made available to the machine operator as a progress diagram, so that he can easily get an overview of the grinding process that has taken place. Several characteristic values can be used to determine the above-mentioned index. These characteristic values then assess the grinding process, the dressing process and the alignment of the workpiece in the grinding machine in different ways. Errors can thus be detected at an early stage that would otherwise only be detected in the measuring room or not at all. These include errors such as workpiece blank errors or set-up errors.

In addition, it is possible to output specific messages about the irregularities if they are taught into the algorithm. In this way, the process can be optimised and an error can be eliminated in a targeted and time-saving manner.

The data recorded in the actual grinding process is compared with data stored in a database. In this way, for example, certain process signals can be assigned to certain areas of the grinding worm; correspondingly, for example, signals can be assigned to certain worm diameters and associated speeds of the grinding worm.

The drawing shows examples of embodiments of the invention.

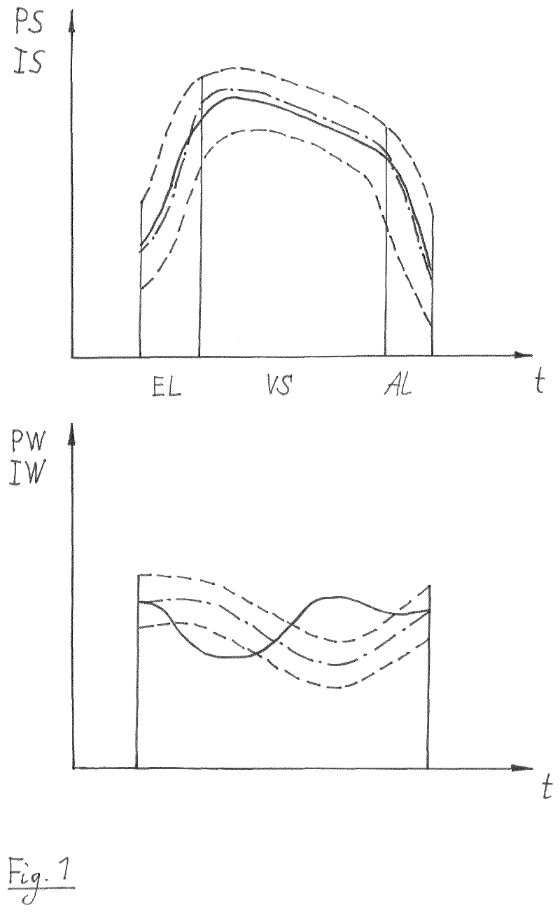

FIG. 1 first shows in a general manner for a first grinding process in the upper figure the course of the power consumption or current consumption of the motor that drives the grinding spindle, and in the lower figure the course of the power consumption or current consumption of the motor that drives the workpiece spindle, and

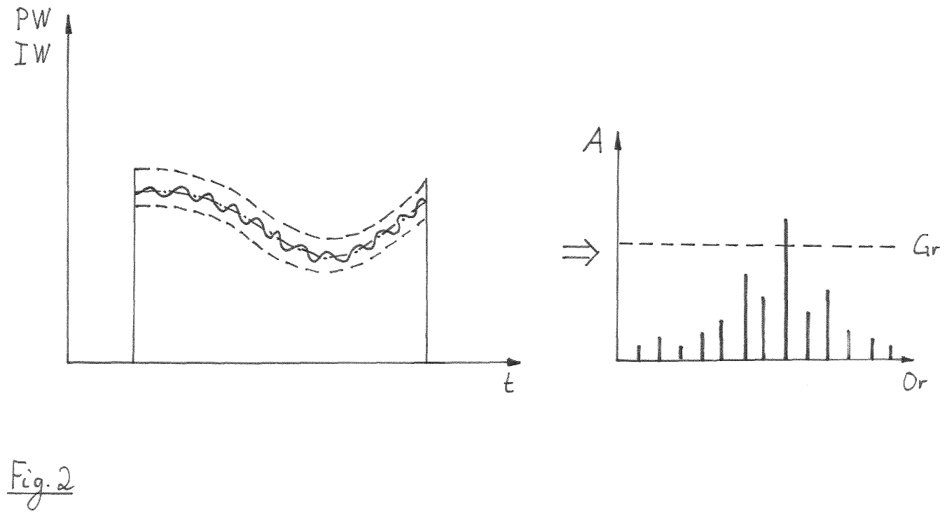

FIG. 2 shows, according to an embodiment of the method according to the invention for a second grinding process, in the left figure the course of the power consumption or the current consumption of the motor which drives the workpiece spindle, and in the right figure the amplitudes of the frequency components of a periodic course of the power or the current obtained from a Fast Fourier Transformation (FFT).

FIG. 1 shows the curve of the power P or current I over time t, which results for a motor for driving a grinding spindle (S) and for the motor for driving a workpiece spindle (W) in a gear grinding machine (shown for a roughing stroke in which the workpiece is ground to quality). At the top of FIG. 1, the curve of the power PS is plotted over time as it is absorbed by the motor of the grinding spindle; the same curve for the amperage IS of the motor is correspondingly obtained via the applied motor voltage. The same applies to the lower illustration in FIG. 1, where the same information is plotted for the motor for driving the workpiece spindle.

The power and current curve to be expected when manufacturing proper gears is shown with the respective dot and dash line. Dashed lines above and below the dot and dash line indicate the permissible tolerance band for the power or current curve. EL indicates the area where a grinding worm enters the gear to be ground, VS indicates the full cut where the actual grinding takes place, and AL indicates the exit of the tool from the workpiece.

The drawn line indicates the actual course of the power or current during the grinding of a specific workpiece.

It can be seen that the power or current consumption at the grinding spindle is normal, which would indicate proper grinding. In fact, however, this is not the case. Due to a flank shape error (namely due to an opposite flank line deviation between the right and the left tooth flank), the grinding spindle consumes the expected current, but not the workpiece spindle, whose power consumption is outside the expected range, as can be seen from the lower illustration in FIG. 1.

It should therefore be noted that, depending on the position or orientation of the flank form error, the power consumption or current consumption at the grinding spindle may well still lie within the permissible tolerance band, while only the simultaneous consideration of the power consumption or current consumption at the workpiece spindle reveals that there have been problems here with the pre-machining of the gear and that there is a corresponding flank form error.

In the present embodiment, it is thus generally provided that (at least) during the engagement of the grinding tool in the toothing to be ground, a first machine parameter in the form of the power or the amperage of the tool spindle and a second machine parameter in the form of the power or the amperage of the workpiece spindle are measured. The two measured machine parameters PS/IS, PW/IW are compared with a predefined stored value. As shown in FIG. 1, it is immediately apparent from the lower partial figure that the course of the power or the current intensity has left the permissible tolerance band, so that a warning signal is emitted. The machine control thus indicates a problem during grinding and that there is possibly no good part.

FIG. 2 shows a specific procedure according to the invention, according to which the said procedure has been specifically designed here to make improved problems visible during the grinding process and to be able to issue a corresponding warning message.

The left-hand illustration in FIG. 2 again shows the power or current consumption at the workpiece spindle (see the drawn-out line), which here lies within the permissible tolerance band. However, it can also be seen that the power or current consumption changes periodically, i.e. it shows the course of a superimposed oscillation.

This superimposed vibration can impose a detrimental fine ripple on the tooth flank, which can lead to noise when the gearing is in use; this is particularly disadvantageous in the field of electromobility.

According to a possible embodiment of the invention, it is therefore envisaged here that, in refinements of the above procedure, a variable derived from the machine parameter (here: from the power or current consumption of the workpiece spindle) is considered in order to assess or evaluate the grinding process.

The recorded waveform in the left partial image in FIG. 2 is subjected to a Fast Fourier Transformation (FFT) to decompose the periodic signal into its components (“harmonics”). This is shown in the right partial image in FIG. 2. Here, the amplitude A of the individual frequency components of the detected periodic signal is schematically plotted above the order Or. It can be seen that a frequency component is above a limit value Gr, so that it can be concluded that no proper grinding process has taken place.

It should be noted that the illustration in FIG. 2 is only very schematic and that, of course, individual limit values can be set for each individual frequency component resulting from the FFT. In particular, expert knowledge stored in the machine control system can be used here to cause it to issue a warning signal in a given case.

With the proposed procedure, it is possible in particular to be able to point out improper process conditions very quickly, before a complete batch of workpieces has possibly been produced incorrectly. This can save considerable costs.

Of course, other parameters can also be used for monitoring the process, with particular thought being given to recording the structure-borne sound of the machine or the hall floor, which equally allow statements to be made, particularly after an analysis of the recorded signals (for example by means of an FFT), about how the grinding process has proceeded and whether it is to be expected that a good part has been ground.

The embodiment shows the use of an FFT. Alternatively, any other known method for frequency analysis can be used, such as in particular the Discrete Fourier Transform (DFT), the frequency analysis by a root mean square analysis (determination of the RMS spectrum), by a determination of the amplitude spectrum, by a cepstrum analysis (including the variants, such as power cepstrum), by a compensation sinus function or by a determination of the auto power spectrum (PSD analysis). In measured value analysis, the described methods are all known as such, so that they do not need to be discussed in more detail here. It is only essential that the individual frequency components of the measured periodic signal components are determined by a frequency analysis and that the results obtained from this are used for the comparison with permissible limit values (in particular for the maximum permissible magnitudes of the individual amplitudes of the “harmonics”).

1-15. (canceled)

16. A method for grinding a toothing or a profile of a workpiece by means of a grinding tool in a grinding machine,
wherein the grinding tool is received on a tool spindle and the tool spindle is rotated by means of a first drive motor,
wherein the workpiece is received on a workpiece spindle and the workpiece spindle is rotated by means of a second drive motor,
wherein at least during the engagement of the grinding tool in the toothing to be ground or in the profile to be ground, a first and a second machine parameter are measured and both measured machine parameters or a variable derived from the machine parameter are compared with a predetermined stored value, wherein a signal is output if at least one of the machine parameters or the variable derived therefrom, taking into account a tolerance band, exceeds or falls below the predetermined stored value,
wherein at least one of the machine parameters or the variable derived from this machine parameter contains periodic signal components, wherein these signal components are broken down into the individual frequency components by a frequency analysis and the frequency components being used for comparison with regard to their frequency and/or their amplitude.

17. The method according to claim 16, wherein both machine parameters or the variables derived from these machine parameters contain periodic signal components.

18. The method according to claim 16, wherein the frequency components are used for comparison only with regard to their amplitude.

19. The method according to claim 16, wherein the frequency analysis is performed by means of a Fast Fourier Transform.

20. The method according to claim 16, wherein the frequency analysis is performed by means of a Discrete Fourier Transform.

21. The method according to claim 16, wherein the frequency analysis is performed by a root mean square analysis (determination of the RMS spectrum) or by a determination of the amplitude spectrum or by a cepstrum analysis or by a compensation sinus function or by a determination of the auto power spectrum (PSD analysis).

22. The method according to claim 16, wherein the measurement of the first and second machine parameters is performed during a predetermined time interval during grinding of the workpiece with the grinding tool.

23. The method according to claim 16, wherein the measurement of the first and second machine parameters is carried out over a predetermined feed path during grinding of the workpiece with the grinding tool.

24. The method according to claim 16, wherein the first machine parameter is the power or current consumption of the motor of the tool spindle.

25. The method according to claim 16, wherein the second machine parameter is the power or current consumption of the motor of the workpiece spindle.

26. The method according to claim 24, wherein from the course of the total power or current consumption of the motor the course of the power or current consumption is subtracted which results in a grinding stroke without cutting of material or only with low cutting in a finishing grinding stroke.

27. The method according to claim 16, wherein one of the machine parameters is the structure-borne sound of the grinding machine or a part thereof, which is detected via a structure-borne sound sensor.

28. The method according to claim 16, wherein the variable derived from the machine parameter is the cutting energy per volume required to machine a predetermined volume of the allowance to be removed on the toothing or on the profile.

29. The method according to claim 16, wherein a characteristic value which characterises the grinding process for the ground workpiece is determined and output from the measured machine parameters and/or from the variable derived from the machine parameter.

30. The method according to claim 16, wherein the grinding tool is a grinding worm and the workpiece is a gear wheel.
